(19) United States
(12) Patent Application Publication
(10) Pub. No.: US 2026/0338088 A1
(43) Pub. Date: Oct. 29, 2026

(54) SUSPENSION SYSTEM FOR A MANHOLE OF A GAS TURBINE, AND ASSOCIATED METHOD

(71) Applicant: Siemens Energy Global GmbH & Co. KG, München (DE)

(72) Inventors: Dirk Müller, Mülheim a.d.Ruhr (DE); Christian Kowalzik, Spremberg (DE)

(21) Appl. No.: 19/117,654

(22) PCT Filed: Sep. 6, 2023
(86) PCT No.: PCT/EP2023/074439

§ 371 Date: Apr. 2, 2025

(30) Foreign Application Priority Data
Oct. 4, 2022 (DE) 10 2022 210 466.8

(51) Int. Cl. F01D 25/28

(52) U.S. Cl. CPC F01D 25/285; F05D 2230/72; F05D 2260/02; F05D 2260/31

(57) ABSTRACT

The invention relates to a suspension system for a manhole, in particular for a manhole of a gas turbine. The system includes a first fastening portion, a second fastening portion for arrangement of connecting pieces at a manhole and a rail that is directly connected to a connecting piece and indirectly to the other connecting piece via a respective pin. The rail includes at least one trolley that can be moved along the rail.

### BACKGROUND

The invention relates to a suspension system for a gas turbine, a gas turbine and a method.

During maintenance work on a gas turbine, in particular a stationary gas turbine, various work tasks are carried out in the exhaust gas duct. In gas turbines, it is possible to make the region acted upon by hot air in the interior of a gas turbine accessible to maintenance staff via a specially designed maintenance access point, known as a manhole.

For example, EP 2 655 808 A1 discloses a method for pulling a bearing body off the rotor of a stationary gas turbine. In this case, a shaft extension is fastened on the relevant end of the rotor and, at the same time, the rotor is supported and/or held in order to free the bearing body of the weight of the rotor. Thereafter, sliding elements are attached between the bearing body and the rotor, whereupon the bearing body can be pushed along the machine axis onto the shaft extension and parked there. Such a shaft extension is very large, long and/or bulky so, although it fits through the manhole, it then has to be rotated or moved to the bearing body.

Since the manhole only has a limited opening and the maintenance tools, such as the shaft extension, can only be moved in the manhole opening, the travel path is in some cases inadequate or it is highly complex to convey the maintenance tools to a suitable location or to position them.

### SUMMARY

This problem is, for example, solved by attaching eyelets to the ceiling in order to extend the suspension and lifting point regions for the travel path of the maintenance tools or turbine components.

The object of the present invention is to propose a novel suspension system, a gas turbine and method, with the aid of which maintenance tools and/or turbine components can, in a simple manner, be guided through a manhole and also travel in a pivotable manner to their place of use.

In addition, the object is achieved according to the invention by a suspension system as claimed in claim 1, a gas turbine with a manhole formed on its outer housing as claimed in claim 8, and a method as claimed in claim 10.

In the dependent claims, further advantageous measures are listed which can be combined with one another respectively in order to obtain further advantages.

The advantages and preferred configurations mentioned in respect of the suspension system can be applied analogously to the gas turbine and the method.

### BRIEF DESCRIPTION OF THE DRAWINGS

Exemplary embodiments of the invention are explained in greater details with reference to the drawings.

In the drawings:

FIG. 1 shows the construction of the suspension system in detail,

FIG. 2 shows a perspective view of the suspension system in a gas turbine,

FIG. 3 shows details of the rotation locking mechanism,

FIG. 4 shows details of the guide slide segment, and

FIG. 5 shows an exemplary mode of operation of the suspension system.

### DETAILED DESCRIPTION

The description and the figures each merely represent exemplary embodiments of the invention.

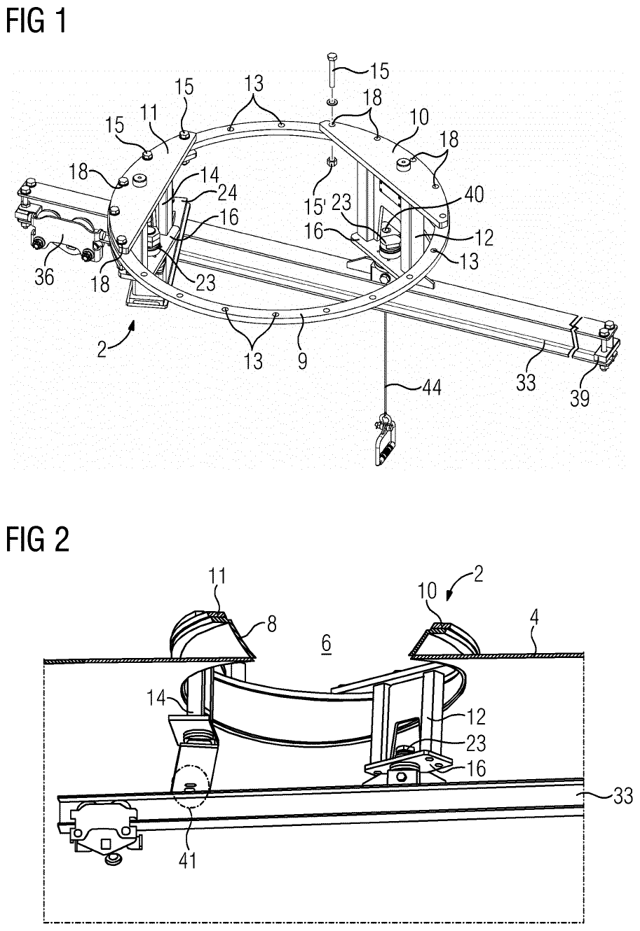

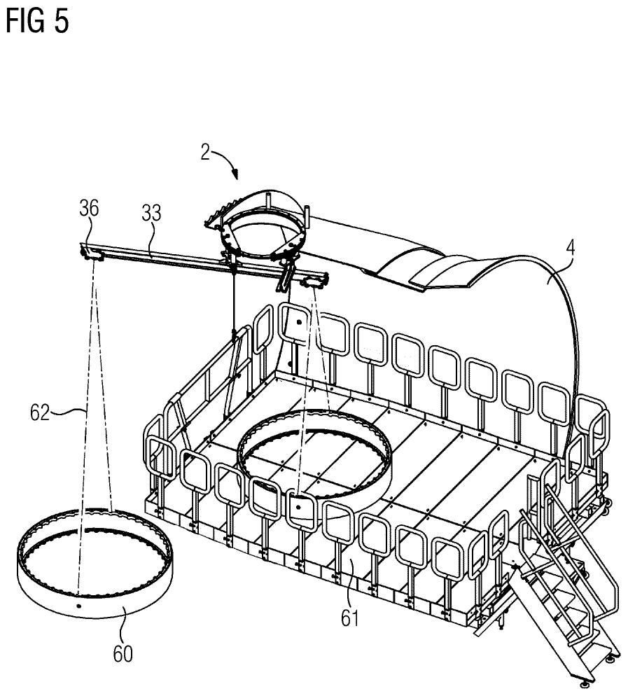

A suspension system 2 (FIG. 1) is explained solely by way of example with respect to a gas turbine 4 (FIGS. 2, 5).

FIG. 2 shows a part of the gas turbine 4 having an opening or manhole 6 which has an, in particular annular, flange 8 and in which the separate suspension system 2 can be and is installed.

The suspension system 2 (FIG. 1) has two, in particular flat, first 10 and second 11 fastening portions which, in the exemplary embodiment shown, in particular take the form of circle segments.

Other shapes are conceivable for the fastening portions 10, 11.

Along the outer circumference of the circular arc of the fastening portions 10, 11, holes 18, through which screws 15 can be passed, are formed in the fastening portions 10, 11, wherein the screws 15 are subsequently passed through corresponding, pre-existing holes (not illustrated) in the flange 8 of the manhole 6 in order to establish a screw connection between the flange 8 and the fastening portions 10, 11 by means of a nut 15′.

The holes 18 are therefore arranged in accordance with the holes in the flange 8.

A ring 9 or ring segments are optionally arranged between the flange 8 and the fastening portions 10, 11.

The ring 9 or the ring segments are used for force distribution, in a similar manner to a washer.

Correspondingly, the ring 9 likewise has holes 13, through which the screws 15 for the fastening portions 10, 11 and the flange 8 can be inserted.

It is not necessary for the fastening portions 10, 11 to be arranged mirror-symmetrically to each other on the ring 9 or the flange 8, as is apparent from FIG. 1. Therefore the distance in the radial circumferential direction along the annular flange 8 or the ring 9 is not necessarily identical for the two fastening portions 10, 11.

The arrangement of the fastening portions 10, 11 is varied in accordance with requirements.

It is possible to shift the fastening portions 10, 11 as desired by at least one hole pattern in a clockwise or counter-clockwise direction.

In this case, the fastening portions 10, 11 preferably have 5 holes 18. However, there may also be more or fewer holes 18, but at least 2 holes 18.

The fastening portions 10, 11 may be identical or different in size.

First and second connecting webs 12, 14, which extend downward in the installed state, are preferably arranged in an identical manner on the first and second fastening portions 10, 11.

The connecting webs 12, 14 preferably extend perpendicularly to the fastening portions 10, 11.

The connecting webs 12, 14 extend perpendicularly to the fastening portions 10, 11 and are in this case preferably formed by two parallel longitudinal bars, each preferably having a plate 16 at the end.

The plate 16 preferably extends parallel to the fastening portions 10, 11.

A bolt 23 is arranged in each case on this plate 16.

The bolt 23 extends in the same direction as the connecting webs 12, 14.

The bolt 23 is rotatably mounted on the plate 16.

Other types of direct or indirect fastening between the bolts 23 and the fastening portions 10, 11 are conceivable.

The configuration and/or arrangement of the fastening portions 10, 11, connecting webs 12, 12, plate 16 and bolt 23 can be varied. It is only necessary for the bolt 23 to be rotatably mounted via any type of rigid connection to the manhole 6.

A rail 33 is fastened directly to the bolt 23 of the first fastening portion 10, so that the rail 33 is mounted so as to rotate relative to the connecting web 12 or the plate 16.

The rail 33 is preferably formed as a double T profile.

The rail 33 preferably extends beyond both sides of the manhole 6.

In the case of a suspension system 2 for a gas turbine 4, the length of the rail 33 can be determined in accordance with the force ratio (moment).

A trolley 36 can be moved back and forth along the rail 33.

Detachable stoppers 39 (FIG. 4) are provided at each end of the rail 33 so that the trolley 36 cannot move easily out of the rail 33.

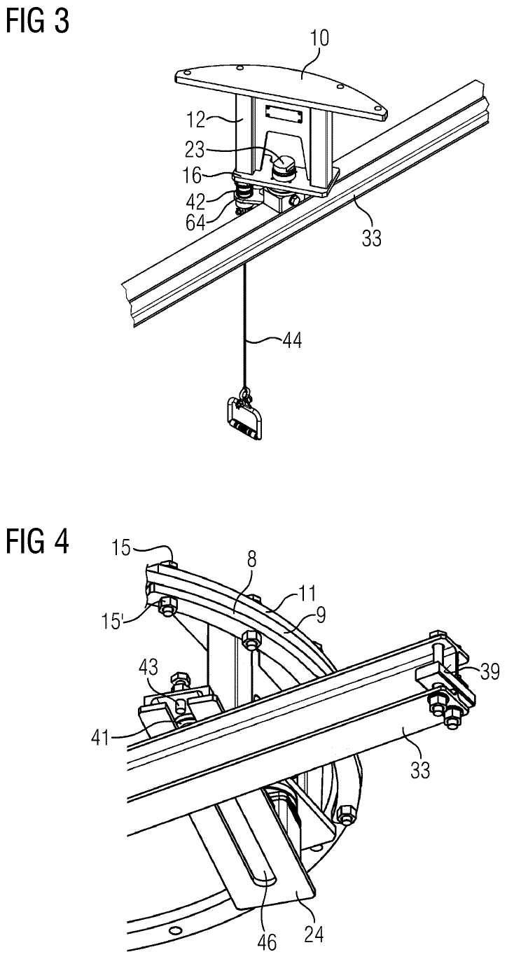

The rail 33 can be locked by a locking bolt 64 via a hole 40 in the plate 16 so that it does not rotate (FIG. 3).

Preferably, there is a rope pull 44 which can release this lock.

The rail 33 is indirectly fastened to the bolt 23 of the second fastening portion 11 via a guide slide segment 24. In this case, the rail 33 is then preferably held and guided by the guide slide segment 24 via a pin 41 (FIG. 4).

The guide slide segment 24 is preferably plate-shaped and elongate.

The guide slide segment 24 is arranged on the bolt 23 in a similar manner and with a similar mode of operation to the rail 33 on the bolt 23 of the first fastening portion 11 and is therefore mounted so as to rotate relative to the second bolt 23.

The pin 41 with an undercut at the free end is guided in an elongate recess 46 (FIG. 4) as a guide region in the guide slide segment 24 and can slide back and forth within the elongate recess 46.

The recess 46 has, in a complementary manner, a projection corresponding to the pin 41 with the undercut.

Only in this way is it possible to pivot the rail 33.

A further stopper 43 is provided at the end of the recess 46 of the guide slide segment 24 so that the pin 41 is unable to slide out of the recess 46.

The connecting web 12 of the first fastening portion 10, on which the rail 33 is held directly, is therefore longer, by the height of the guide slide segment 24 in the arrangement in the second fastening portion 11, than the connecting web 14 of the second fastening portion 11, to allow the rail 33 to be held horizontally.

The manner in which the rope pull 44 can be used is illustrated in greater detail in FIG. 3.

If the rope pull 44 is pulled, the spring 42 relieves the locking bolt 64, and the lock holding the rail 33 relative to the connecting web 12 or the plate 16 is lifted, so the locking bolt 64 is pulled out of the hole 40.

The guide slide segment 24 is illustrated in greater detail in FIG. 4.

The FIG. shows how the pin 41 is guided and held in a recess 46.

The recess 46 is formed on the underside (as viewed from the manhole 6) of the guide slide segment 24.

The recess 46 preferably remains open at one end so that the individual parts of the suspension system 2 can be dismantled after use.

FIG. 5 shows an application of the suspension system 2.

Fastened to the trolley 36 by suspension means 62, such as, in particular, ropes or chains, is a component 60, which can be brought into a housing of the gas turbine 4 by shifting the trolley 36 in a corresponding direction, and which can be supported there, for example on a work platform 61. FIG. 5 demonstrates this by showing the component 60 outside the gas turbine and inside the gas turbine 4.

1. A suspension system for a manhole, in particular for a manhole of a gas turbine the suspension system comprising:
a first fastening portion and a second fastening portion for arranging connecting webs on a manhole wherein a rail is rotatably arranged and is connected directly on one connecting web and indirectly on the other connecting web by a bolt in each case, wherein the rail has at least one trolley which can travel along the rail.

2. The suspension system as claimed in claim 1, in which, in particular in each case, a plate is connected to the connecting webs at the end of the connecting web, wherein, in each case, the bolt is connected to and rotatably mounted on the plate.

3. The suspension system as claimed in claim 2, in which, on a connecting web of the first fastening portion the rail is mounted by means of the bolt so as to rotate relative to the first fastening portion.

4. The suspension system as claimed in in claim 3, in which, on the other connecting web of the second fastening portion a guide slide segment is mounted on the bolt so as to rotate relative to the second fastening portion wherein the rail is held and guided by the guide slide segment so that the rail can be rotated.

5. The suspension system as claimed in claim 4, in which a pin, which has an undercut at the free end, on the rail is guided in an elongate recess in the guide slide segment and can slide back and forth within the elongate recess.

6. The suspension system as claimed in claim 5, in which the rail can be rotationally locked on the connecting web of the first fastening portion by a rotation locking mechanism.

7. The suspension system as claimed in claim 6, in which the fastening portions are releasably arranged on a ring or a flange.

8. A gas turbine having a manhole with a flange, in particular in the exhaust region, in which a suspension system as claimed in claim 1.

9. The gas turbine as claimed in claim 8, in which a ring arranged between the fastening portions and a flange of the manhole.

10. A method for transporting or installing, removing components by means of a suspension system as claimed in claim 1.

11. The method as claimed in claim 10, in which the arrangement of the fastening portions relative to one another is changed with respect to the radial distance.
